(19) United States
(12) Patent Application Publication
(10) Pub. No.: US 2004/0143956 A1
(43) Pub. Date: Jul. 29, 2004

(54) Method and apparatus for insertion of stator core liners

(76) Inventors: Lisa K. Haller, Anderson, IN (US); Michael Jeffrey Lowry, Indianapolis, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/354,615

(22) Filed: Jan. 29, 2003

(51) Int. Cl. H02K 15/00

(52) U.S. Cl. 29/596; 29/606

(57) ABSTRACT

A method for manufacturing a stator core of an electric machine is provided. The method comprises: inserting a motor winding into stator slots defined in the stator core; installing an insulating strip into each of the openings in each of stator slots; and installing a magnetically conductive retaining strip in conductive contact with the stator core at opposing sides of each the stator slots such that a conducting space is defined by the conducting strips. The motor windings are inserted into the stator slots through an opening without tooth tips of the stator slots. The conducting space is intermediate to each of the openings to restrict the openings to a predetermined dimension. The insulating strips prevent electrical conduction between the conducting strips and the motor windings.

### CROSS REFERENCE TO RELATED APPLICATION

This application is related to commonly owned and assigned U.S. patent application, Ser. No. ______, attorney docket number DP-305366 filed contemporaneously with this application and the contents of which are incorporated by reference herein.

### TECHNICAL FIELD

This application relates to stator cores for electric machines. More specifically, this application relates to tools and processes for inserting a liner into a stator core of an electric machine.

### BACKGROUND

Electric machines (e.g., motors or generators) have a stator core secured within a housing. A rotor mounted on a shaft is positioned within the stator core and is rotatable relative to the stator core about the longitudinal axis of the shaft. The stator core includes a plurality of copper wire coils inserted into insulated slots in a steel core. When an electrical current is supplied to the copper coils, a magnetic field is established in the steel core.

Each of the insulated slots of the stator core has a pair of tooth tips to partially cover the opening of the insulated slot. The tooth tips reduce the eddy current losses that would otherwise result on the rotor surface due to airgap reluctance/flux variations. Various winding methods are used to insert the copper coils into the slots of the steel core. Due to the limitations of the winding methods in inserting the copper coils into the narrow slot openings, the percentage of copper in the slots can be between 50 and 60 percent. The percentage of copper in the slots is directly porportional to the performance and efficiency of the motor. Thus, the tooth tips of prior stator cores have been a limiting factor in increasing the performance and efficiency of the motor.

Eliminating the tooth tips from the steel core can increase the percentage of copper in the slots. However, removal of the tooth tips increases the eddy current losses that result on the surface of the rotor due to air gap reluctance or flux variations. For example, stator cores having too large of an opening between the tooth tips lead to a large magnetic field variation between the rotor and the stator core. The magnetic field variation generates eddy current losses on the surface of the rotor, or additional load on the motor.

Accordingly, it is desirable to manufacture a stator core that enables a high percentage of copper in the slots, while still providing a slot opening that is sufficient to mitigate eddy current losses.

### SUMMARY

A method for manufacturing a stator core of an electric machine is provided. The method comprises: inserting a motor winding into stator slots defined in the stator core; installing an insulating strip into each of the openings in each of the stator slots; and installing a magnetically conducting strip that retains the windings in the stator slots by contacting the stator core between each of the stator slots such that a nonconducting opening is defined between the conducting strips. The motor windings are inserted into the stator slots through an opening without tooth tips of the stator slots. The conducting space is intermediate to each of the openings to restrict the openings to a predetermined dimension. The insulating strips prevent electrical conduction between the conducting strips and the motor winding.

An insertion tool for installing a retaining and insulating member into a stator core of an electric machine is also provided. The tool comprises an inner core and a plurality of fingers disposed circumferentially about the inner core. The fingers corresponding to slots defined within a central bore of the stator core. The fingers compress or hold motor windings in the slots. The insertion tool moves in an axial direction through the central bore in order to push, pull, or draw the retaining and insulating member into the stator core. The retaining and insulating member is moved into the stator core so that the insulating layer rests in the slots, while the conducting layer is in conductive contact with the stator core.

A method for making a retaining and insulating member for an electric machine is also provided. The method comprises: removing a plurality of first portions of a magnetically conducting tape to define conducting spaces separating conducting strips, and a first bridging portion connecting all of the conducting strips to one another; removing second portions of an insulating tape to define insulating spaces separating insulating strips, and a second bridging portion connecting all of the insulating strips to one another; and connecting the insulating tape and the conducting tape to one another so that the conducting strips are intermediate to the insulating spaces, and the insulating strips are intermediate to the conducting spaces.

An alternative method for making a retaining and insulating member for an electric machine is also provided. The method comprises defining insulating spaces separating insulating strips in an insulating sleeve, and a bridging portion connecting all of the insulating strips to one another; connecting the insulating sleeve about a continuous conducting sleeve; and removing a portion from the continuous conducting sleeve to define conducting spaces separating conducting strips. Here, the conducting strips are intermediate to the insulating spaces, and the insulating strips are intermediate to the conducting spaces.

The above-described and other features and advantages of the present invention will be appreciated and understood by those skilled in the art from the following detailed description, drawings, and appended claims.

### BRIEF DESCRIPTION OF THE DRAWINGS

FIG. 1 is a perspective view of an electric machine;

FIG. 2 is an exploded view of the electric machine of FIG. 1;

FIG. 3 is a sectional view of FIG. 2 along lines 3-3;

FIG. 4 is a front view of an exemplary embodiment of an insulating and retaining member in a stator core;

FIG. 5 is a sectional view of FIG. 4 taken along lines 5-5;

FIG. 6 is a schematic view of an exemplary embodiment of a method of inserting an insulating and retaining member into a stator core;

FIG. 7 is a top plan view of an exemplary embodiment of an insertion tool for inserting an insulating and retaining member into a stator core;

FIG. 8 is a top plan view of the tool of FIG. 7 in use with a stator core;

FIGS. 9-12 are schematic views of alternative exemplary embodiments of insertion tools for inserting an insulating and retaining member into a stator core;

FIG. 13 is a schematic view of a manufacturing process for making an insulating and retaining member having a one-piece construction;

FIGS. 14-15 illustrate alternative exemplary embodiments of the insulating and retaining member of FIG. 13; and

FIG. 16 is a schematic view of a manufacturing process for making an insulating and retaining member.

### DESCRIPTION OF THE PREFERRED EMBODIMENT

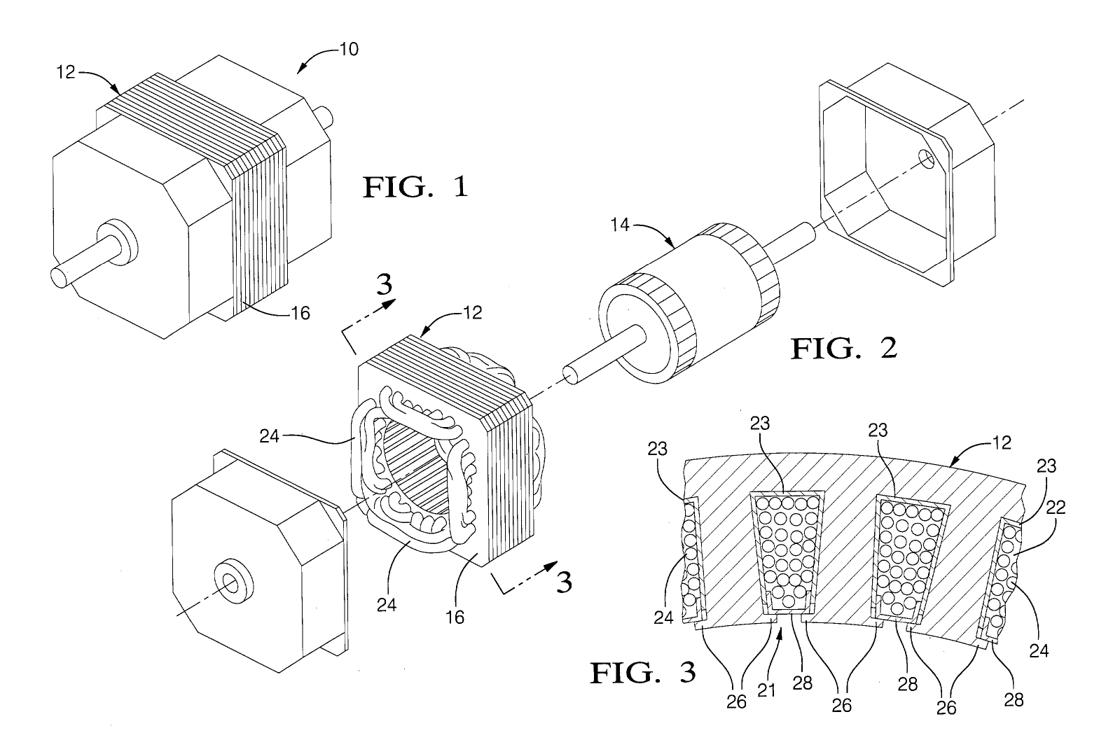

Referring now to FIGS. 1-3, and for purposes of generally illustrating an electric machine 10. An electric machine 10 is provided by way of example. The electric machine 10 includes a stator core 12 and a rotor 14. The stator core 12 is formed of a stack of laminations 16. The laminations 16 are preferably formed of steel having a silicon content of about 0.0-6.0% by weight (e.g., electric steel). The laminations 16 are coated with an electrically non-conducting or insulating coating 18. Thus, the stator core 12 comprises the stack of laminations 16 and the coating (not shown).

It should be recognized that the stator core is described above by way of example only as including a stack of layers. Of course, and as other applications require, use of continuously wound stator cores, segmented stator cores, solid metal stator cores, powdered metal stator cores, laminated metal stator cores, and the like are contemplated.

Moreover, it should be recognized that the stator core 12 is described above by way of example only as being formed of steel. Of course, and as other applications require, the stator core may be formed of any magnetically conducting, permeable, or ferromagnetic material such as but not limited to electrical steel, structural steel, stainless steel (e.g., 400 series), iron, nickel, cobalt, conducting polymers, and the like.

The laminations 16 each comprise a central bore 20 <<not shown>> for receiving the rotor 14 and a plurality of spaced apart slots 22. The individual laminations 16 are stacked such that the central bores 20 and the slots 22 are aligned with one another to form the stator core 12. The openings or slats 22 each include a pair of tooth tips 26 disposed at either side of the openings of the slots 22. Thus, the slots 22 have a slot opening 21 that is restricted in width by the tooth tips 26.

The width of the opening 21 is an important variable in the efficiency of the motor 10. The width of the opening 21 regulates the eddy current losses that would otherwise result on the surface of the rotor 14 due to air gap reluctance or flux variations. For example, an opening 21 that is oversized leads to a large magnetic field variation between the rotor 14 and the stator core 12. The magnetic field variation generates eddy current losses on the surface of the rotor 14, or an additional load on the motor 10, both of which reduce the efficiency of the motor. Alternately, no opening 21 results in a closed slot stator core 12. Closed slot stator cores result in a leakage of flux, or a flux transfer between alternating poles of the stator 12, which also reduces the efficiency of the motor. Thus, the tooth tips 26 are important to ensure that the width of the opening 21 is equal to a predetermined dimension. This predetermined dimension is sufficient to minimize or reduce the eddy current losses that would otherwise result on the surface of the rotor 14 without leading to a large magnetic field variation between the rotor and the stator core 12 and without resulting in excess leakage of flux, or a flux transfer between alternating poles of the motor 10.

The slots 22 of the stator core 12 are provided with a layer of electrical insulation 23. The insulation 23 is, for example, an insulating paper (e.g., NOMEX), MYLAR (e.g., KAPTON), polymers, and combinations of any of the foregoing. The insulation 23 prevents electrical conduction between the stator core 12 and windings 24 that are inserted in the slots 22. A retaining and insulating strip 28 secures the windings 24 in the slots 22. The retaining and insulating strip 28 is also formed of an electrically non-conductive material. Thus, the retaining and insulating strip 28 prevents electrical conduction between the windings 24 and the tooth tips 26.

The windings 24 are inserted into the slots 22 in a known manner. For example, the windings 24 are commonly inserted into slots 22 through the opening 21 (e.g., a radial insertion of the windings). During such radial insertion, the narrow width of the opening 21 results in a less than complete filling of the slots 22 with the winding 24. Commonly, such radial insertion results in about 50% to 60% of each slot 22 being filled with the windings 24. This low slot fill percentage causes the motor 10 to exhibit less than maximum performance.

Since the tooth tips maintain the opening 21 at the predetermined dimension, the elimination of the tooth tips is not desirable from the standpoint of motor performance. However, the elimination of the tooth tips 26 is desirable from the standpoint of manufacturability of the motor. Namely, a higher slot fill percentage could be achieved without the tooth tips 26, which would increase the efficiency of the motor. Additionally, the elimination of the retaining and insulating strip 28 is desirable because the installation of these strips requires additional manufacturing time, difficulty, and expense.

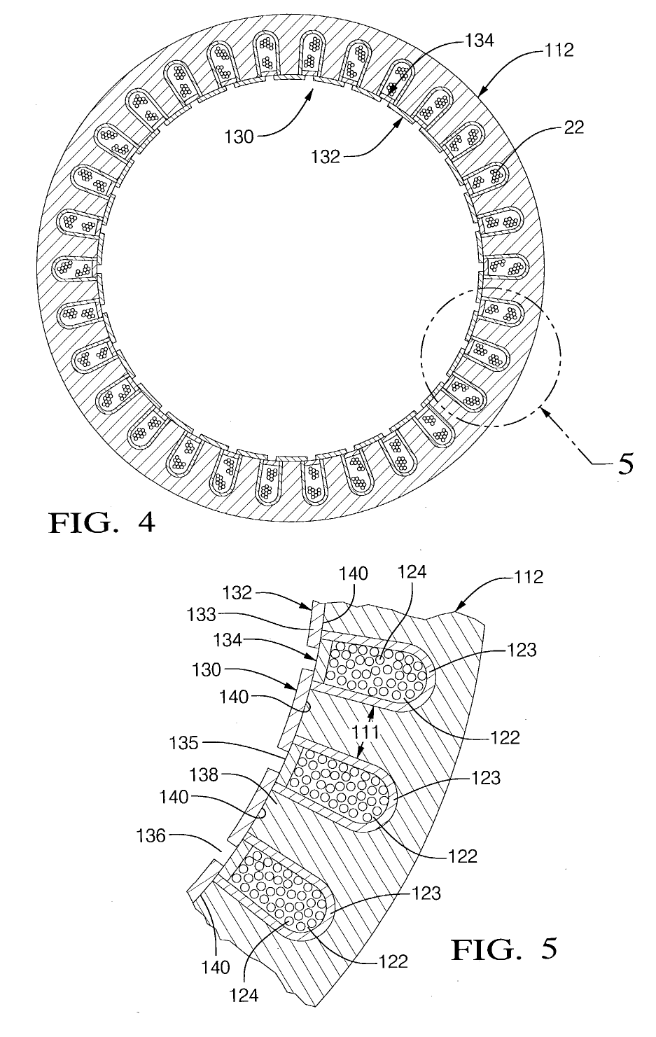

In accordance with the present disclosure, it has been found that an insulating and retaining member can be used to replace both the tooth tips and the retaining and insulating strips. The insulating and retaining member resolves the above described and other disadvantages. As provided in detail below, the insulating and retaining member enables the stator core to have slots without tooth tips for purposes of inserting the windings. The insulating and retaining member is inserted in the slots after the windings to restrict the slot opening to a desired dimension and to retain the windings in the slots. An exemplary embodiment of the present disclosure is illustrated in FIGS. 4 and 5.

Referring now to FIGS. 4 and 5, a stator core 112 constructed in accordance with an exemplary embodiment of the present disclosure is illustrated. Stator core 112 is illustrated comprising slots 122 each having a slot opening 121.

Here, the slot openings 121 do not have tooth tips to restrict the width of the opening 121. Since the slots 122 have no tooth tips, the opening 121 is larger than available in previous electric machines. Thus, the windings 124 are more easily inserted into the slots 122 through the opening 121. This permits a more complete filling of the slots 122 with the windings 124. It should be noted that the windings 124 are not illustrated in FIG. 4 for purposes of clarity.

Thus, increasing the percentage of the windings 124 in the slots 122 is simplified by eliminating the tooth tips from the stator core 112. Moreover, the windings 124 are more easily inserted into the slots 122, even if windings having a large diameter or cross section are used. For example in an exemplary embodiment, over eighty percent (80%) of the slots 122 are filled with the windings 124. Accordingly, the stator core 112 increases the ease to manufacture stator cores having a high percentage of windings 124 in the slots 122.

As discussed above, the tooth tips of prior stator cores restrict the stator core opening to a dimension that is sufficient to mitigate eddy current losses that result on the surface of the rotor 114.

Further, the retaining strips of prior stator cores were used to retain the windings in the stator core. In the present disclosure, an insulating and retaining member 130 is provided on the core 112 after insertion of the windings 124. The insulating and retaining member 130 is configured to replace both the tooth tips and the retaining strips.

The member 130 comprises a conducting layer 132 and an insulating layer 134. The conducting layer 132 comprises a plurality of conducting strips 133 separated by conducting spaces 136. Similarly, the insulating layer 134 comprises insulating strips 135 separated by insulating spaces 138. The conducting layer 132 and the insulating layer 134 are connected by way of an adhesive 140, such as nitrocellulose, epoxy, alkyd, polyvinyl acetate/acetal/chloride, or urethane. Accordingly, the member 130 has a one-piece, ring-like construction. Here, the conducting layer 132 and the insulating layer 134 are connected so that the conducting strips 133 and the insulating strips 135 overlap one another. Namely, the conducting strips 133 are intermediate to the insulating spaces 138, and the insulating strips 135 are intermediate to the conducting spaces 136.

The conducting spaces 136 are configured to mimic the opening between the tooth tips of conventional stator cores. Namely, the conducting spaces 136 separate the conducting strips 135 from one another by a predetermined distance. This predetermined distance is configured to be sufficient to mitigate the eddy current losses discussed above that would otherwise result on the surface of the rotor. The insulating spaces 138 are configured to be equal to or slightly smaller than the distance 111 between the slots 122 of the stator core 112.

In an exemplary embodiment, the member 130 has an overall thickness of about 0.75 mm to 1.25 mm. Here, the conducting layer 132 has a thickness of about 0.5 mm to 1.0 mm, and the insulation layer 134 has a thickness of about 0.25 mm. It should be recognized that the thickness of the insulating and retaining member 130 and its various layers are described above by way of example only. Of course, larger and/or smaller thicknesses for the member 130, the conducting layer 132, and/or the insulating layer 134 are contemplated.

After the insertion of the windings 124 in the slots through the opening 121, the conducting layer 132 is connected to the stator core 112 by way of the adhesive 140. In this installed position, the insulating strips 135 rests in each of the slots 122 to electrically insulate the windings 124 from the conducting strips 133. However, the conducting strips 133 are in magnetic conductive contact with the stator core 112 with the conducting spaces 136 intermediate to the slot 122.

In the installed position, the conducting strips 133 restrict the width of the opening 121 of each of the slots 122 to the predetermined dimension. Thus, the conducting layer 132 replaces the tooth tips. Namely, the conducting strips 133 reduce the eddy current losses that would otherwise result on the rotor surface due to airgap reluctance/flux variations by reducing the width of the opening 121 of each of the slots 122. Accordingly, the member 130 replaces the function of the tooth tips of prior electric machines.

Further, the member 130 is connected to the stator core 112 across the opening 121. In this position, the conducting layer 132 works in combination with the insulating layer 134 to retain the windings 124 in the slots 122. Accordingly, the member 130 also replaces the retaining strips of prior electric machines.

In summary, the member 130 retains the windings 124 in the slots 122 and reduces the eddy current losses that would otherwise result on the rotor surface due to airgap reluctance/flux variations by restricting the width of opening 121 to the predetermined dimension.

It should be recognized that the conducting layer 132, the insulating layer 134 and/or the stator core 112 are described above by way of example only as being connected by the adhesive 140. Of course, other means for connecting the layers and/or the stator core are considered within the scope of the present disclosure. For example, other connecting means such as, but not limited to, interlocking clips, biasing clips, an interference fits, welding, brazing, soldering, screws, and/or combinations thereof are considered within the scope of the present disclosure.

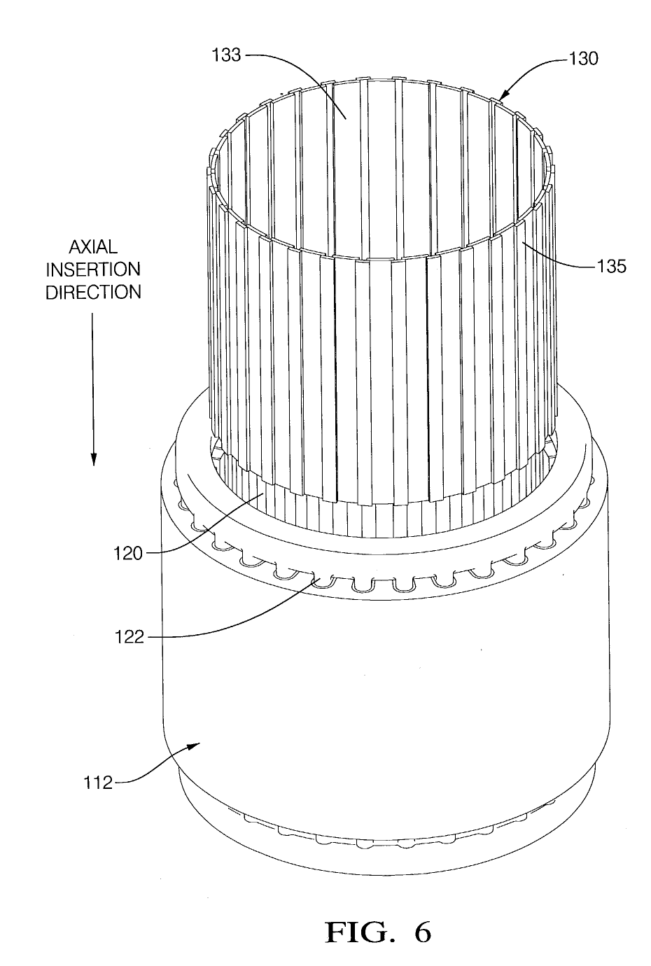

Turning now to FIG. 6, the insulating and retaining member 130 is illustrated being inserted into the central bore 120 of the stator core 112. The member 130 is axially inserted through the bore 120 of the stator core 112. Axial insertion is defined as the insertion of the member 130, the layers 132 and 134 or portions thereof into the central bore 120 of stator core 112 along the axis of the central bore. Here, the member 130 is inserted such that the insulating strips 135 rest in each of slots 122 and such that the conducting strips 133 restrict the width of the openings 121 of each of the slots to the predetermined dimension. Once the member 130 has been inserted, the adhesive 140 bonds the conducting strips 133 to the stator core 112 in a magnetically conducting manner.

It should be recognized that the member 130 is illustrated by way of example only as having a one-piece, ring-like construction. Of course other configurations of the member 130, such as, but not limited to multiple piece construction, tape-like construction, semi-circular construction, and the like are contemplated.

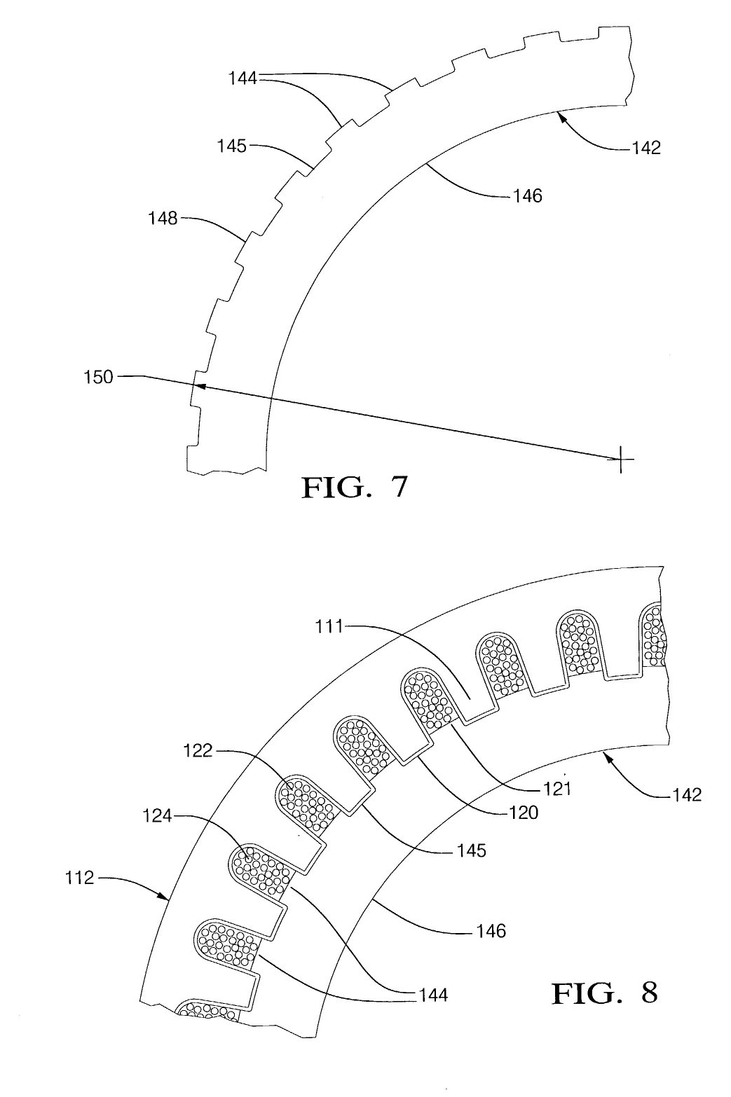

Referring to FIGS. 7 and 8, an exemplary embodiment of an insertion tool 142 is provided. After the insertion of the windings 124 into the slots 122 but before the axial insertion of the member 130 into the bore 120, the windings often have a tendency to creep, elastically rebound, and/or move out of the slots into the bore. This movement of the windings 124 into the bore 120 has the potential to interfere with the axial insertion of the member 130 described above. The insertion tool 142 is configured to mitigate the effects of this “creep” of the windings 124 either before or during the insertion of the member 130. Additionally, the insertion tool 142 is configured to compress the windings 124 into the slots 122 to further increase the slot fill percentage afforded by the member 130.

The tool 142 comprises a plurality of fingers 144 disposed circumferentially about its inner core 146. The fingers 144 have a tip width 148 that is equal to or slightly smaller than the opening 121 of the slots 122 of the stator core 112. The fingers 144 also have a radial dimension 150 that is equal to or slightly larger than the radius of the central bore 120 of the stator core 112. Additionally, the fingers 144 are separated from one another by a space 145 that is equal to or slightly larger than the distance 111 between the slots 122 of the stator core 112. Accordingly, the tool 142 is configured to fit within the bore 120 of the stator core 112. The tip width 148 of the fingers 144 and the space 145 between each finger allows the fingers correspond to the slots 122 of the stator core 112. Additionally, the radial dimension 150 being equal to or slightly larger than the radius of the central bore 120 allows the fingers 144 to compress or hold the windings 124 in the slots 122, which allows the member 130 to more easily be inserted into the bore (e.g., without interference from the windings).

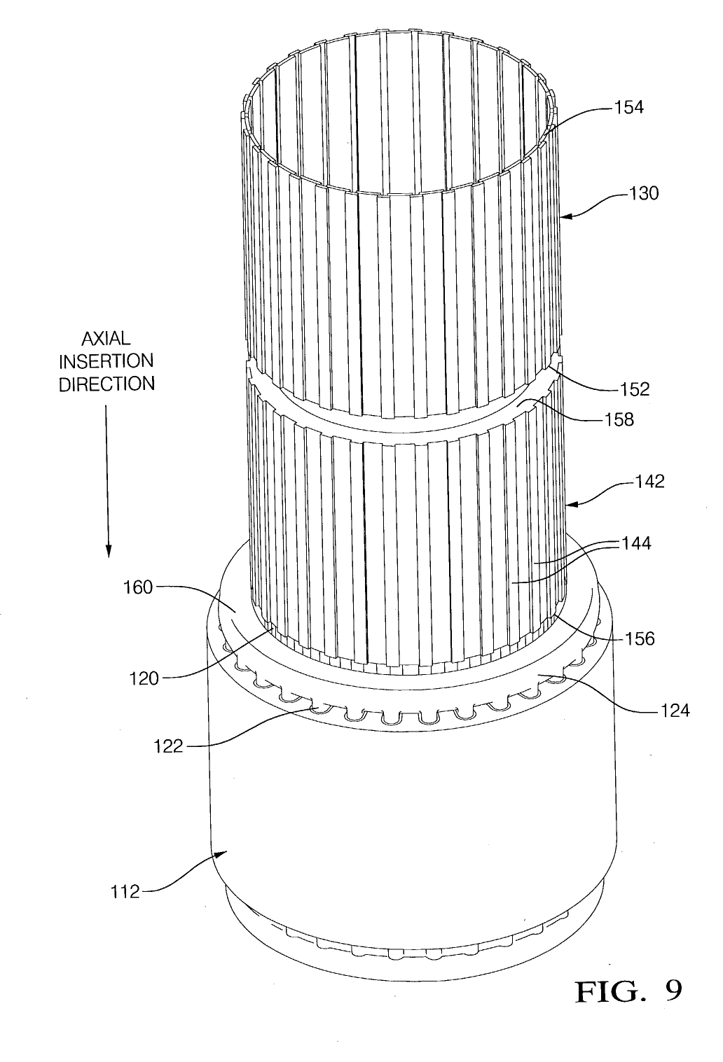

The use of the tool 142 is illustrated with reference to FIG. 9. Here, the member 130 includes a leading edge 152 and a trailing edge 154. Similarly, the tool 142 includes a leading edge 156 and a trailing edge 158. The leading edge is defined herein as the edge proximate to direction of movement. Conversely, the trailing edge is defined herein as the edge remote from the direction of movement.

During assembly, the leading edge 152 of member 130 placed is adjacent to the trailing edge 158 of the tool 142. The leading edge 156 of the tool 142 is axially inserted into the central bore 120 at the upper end 160 of the stator core 112. The tool 142 is fed (e.g., pushed, pulled, and/or drawn) through the bore 120. While the tool 142 is within the bore 120, the fingers 144 compress or hold the windings 124 into the slots 122.

The member 130 is fed into the bore 120 behind the tool 142, while the tool is compressing the windings 124. The tool 142 is fed through the bore 120 until its trailing edge 158 is removed from the lower end 162 of the stator core 112. At this point, the trailing edge 154 of the member 130 is approximately even with the upper end 160 of the stator core 112 and the leading edge 152 of the member is approximately even with the lower end 162 of the stator core.

In an alternative exemplary embodiment, the leading edge 152 of the member 130 is connected to the trailing edge 158 of the tool 142. In this embodiment, the member 130 is fed into the bore 120 as the tool 142 is fed through the bore. After the insertion of the member 130 into the bore 120 is completed, the member and tool 142 are disconnected. By way of example, the member 130 is connected to the tool 142 by way of a magnetic field, an adhesive, a mechanical connector and the like.

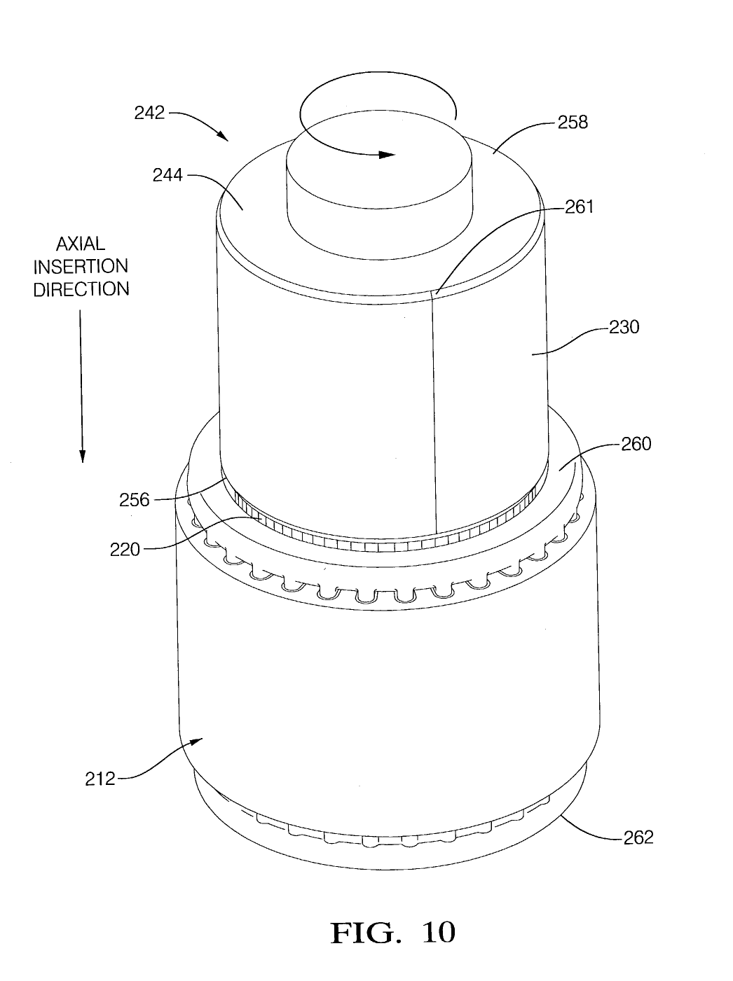

Referring now to FIG. 10, an alternative exemplary embodiment of an insertion tool 242 is illustrated. Here, the member 230 is illustrated having a one-piece, tape-like construction. In this configuration, the member 230 further comprises opposing ends 261.

The tool 242 is configured to move not only in the axial direction with respect to the stator core 212, but also to rotate about the axis of the stator core. During assembly, member 230 is placed over tool 242. The leading edge 256 of the tool 242 is axially inserted into the central bore 220 at the upper end 260 of the stator core 212. The tool 242 is fed (e.g., pushed, pulled, and/or drawn) through the bore 220. During the feeding of the tool 242, the tool is rotated. Thus, while the tool 242 is within the bore 220, the fingers 244, as illustrated in callout 144 of FIG. 7, compress the windings 224 into the slots 222.

The tool 242 is fed through the bore 220 until its trailing edge 258 is removed from the lower end 262 of the stator core 212. In this embodiment, the rotation of the tool 242 further acts to roll the member 230 into the stator core 212.

In an exemplary embodiment, the leading edge 252 of the member 230 is connected to the trailing edge 258 of the tool 242 such that feeding and rotating the tool through the bore 220 simultaneously feeds and rolls the member into the bore. After the insertion of the member 230 into the stator core 212 is completed, the member and tool 242 are disconnected.

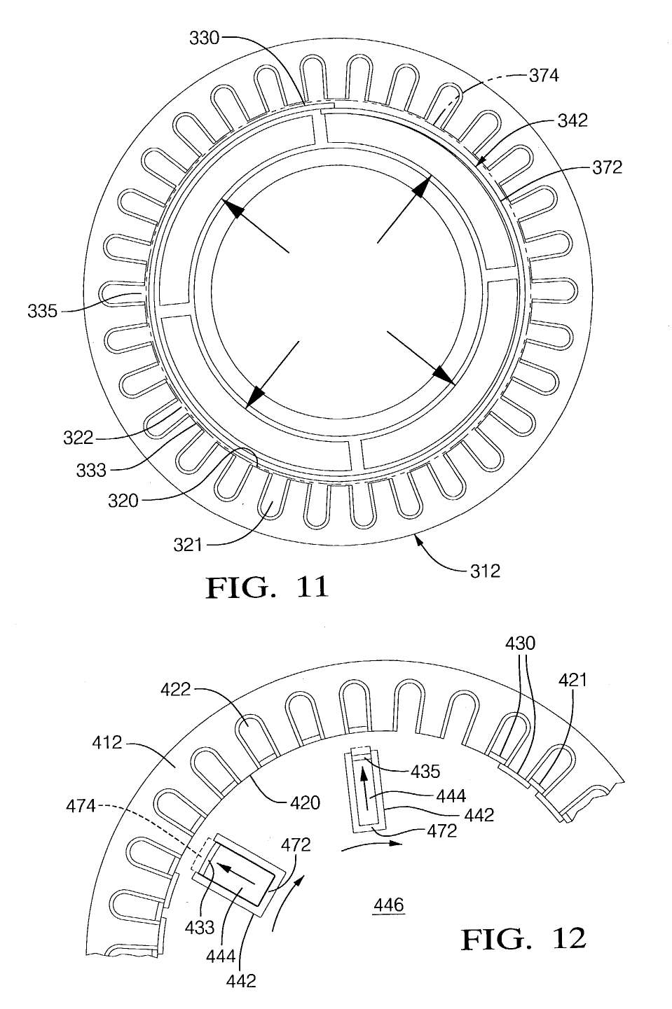

Referring now to FIG. 11, another alternative exemplary embodiment of an insertion tool 342 is provided. For purposes of clarity, the windings 324 are not shown and the member 330 is illustrated having the one-piece, tape-like construction. In this embodiment, the tool 342 is configured to move not only in the axial direction with respect to the stator core 312, but also to expand radially within the bore 320. Radial insertion is defined as the insertion of the member 330 and or its components radially outward from within the central bore 320 of the stator core 312.

The tool 342 is adapted to move between a retracted position 372 and an extended position 374 (shown in phantom). The tape-like construction of the member 330 allows the member to be coiled about the tool 342 when the tool is in its retracted position 372. In this position, the tool 342 with the member 330 disposed thereon has an outer diameter smaller than the diameter of the central bore 320.

Next, the tool 342 is inserted axially into the central bore 320, where it is expanded to the extended position 374. When the tool 342 is in the expanded position 374, the insulating strips 335 rest in each of slots 322 and the conducting strips 333 restrict the width of the opening 321 of the slots 322 to the predetermined dimension. At this point, the member 330 is connected to the stator core 312, and the tool 342 is returned to its retracted position 372 prior to removal from the bore 320. In this manner, the tool 342 not only compresses the windings 324 in slots 322, but also inserts the member 330.

It should be recognized that in the tool 342 it is illustrated by way of example only with the member 330 having the one-piece tape-like construction. Of course, it should be recognized that the tool works equally as well when the member 330 has two separate layers 332 and 334. Here, the member 330 is built or formed within the stator core 312 by first inserting the insulating layer 332, followed by inserting the conducting layer 334.

Referring now to FIG. 12, yet another alternative exemplary embodiment of an insertion tool 442 is provided. Again, the windings 424 are not shown for purposes of clarity. The tool 442 includes one or more fingers 444 disposed circumferentially about its inner core 446. The fingers 444 are adapted to move between a retracted position 472 and an extended position 474. In this embodiment, the tool 442 is configured to individually insert the conducting strips 433 and the insulating strips 435. Thus, the member 430 is not of a one-piece construction, but rather is built in the stator core 412 by the tool 442. Namely, the member 430 comprises the conducting strips 433 and the insulating strips 435, which are individually placed in position in the bore 430 by the tool 442 to build the member in the stator core 412.

The tool 442 is inserted axially into the central bore 420 with the fingers 444 in the retracted position 472. An insulating strip 435 is disposed at each of the fingers 444, and the fingers are expanded to the extended position 474. The insulating strips 435 rests in each of slots 422 when the tool 442 is in the expanded position 474. Next, the tool 442 is retracted to the retracted position 474, and a conducting strip 433 is disposed at each of the fingers 444. The fingers 444 are then expanded to the extended position 474 so that the conducting strips 433 are placed across the slots 422 such that the conducting space 436 is defined intermediate to the opening 421.

The member 430 is connected to the stator core 412, and the tool 442 is returned to its retracted position 472 prior to removal from the bore 420. In this manner, the tool 442 not only compresses the windings 424 in slots 422, but also builds the member 430 within the stator core 412.

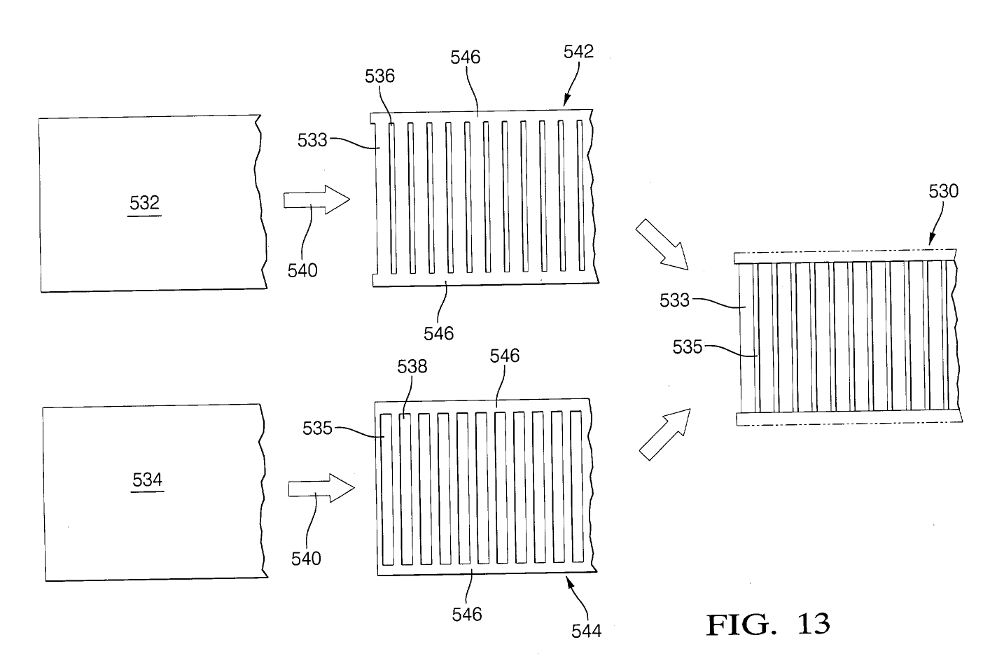

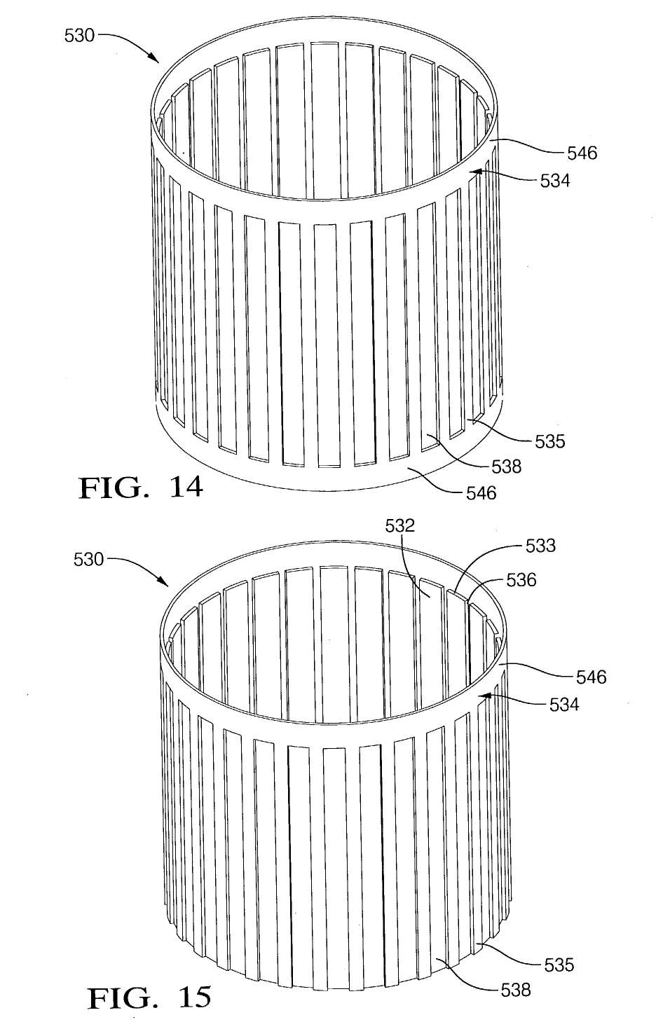

Referring now to FIG. 13, an exemplary embodiment for manufacturing a member 530 having a one-piece, tape-like construction is illustrated.

The manufacture of the member 530 begins with a tape 532 of insulating material and a tape 534 of conducting material. Preferably, the conducting tape is electrical steel, iron, low carbon steel, or other ferromagnetic material, while the insulating tape is wedge paper (e.g., NOMEX), MYLAR (e.g., KAPTON), polymers, or the like.

The magnetically conducting layer 532 is cut or manufactured into a ribbon form 542 and insulating layer 534 is also cut or manufactured into a ribbon form 544. An adhesive 540 is applied to one side of each of the tapes either before or after the process providing ribbon forms 542 and 544.

Ribbon 542 is processed to have slits 536 on either side of strips 533, and ribbon 544 is processed to have slits 538 on either side of strips 535. Slits 536 have a width sufficient to properly located strips 533 to replace the tooth tips and reduce the eddy current losses that would otherwise result on the surface of rotor 14 due to air gap reluctance/flux variations. In addition, strips 533 are of a sufficient width to traverse between slots 122 while also having a remaining portion that hangs over the slot opening. Slits 538 have a width sufficient such that strip 535 is received within slots 122 of stator core 112. Strip 535 is also configured to be received within slot 122. A bridging portion 546 remains on both ribbons 542 and 544. Bridging portion 546 holds strips 533 and 535 of ribbons 542 and 544 in place until the ribbons are connected.

Next, ribbon 544 and ribbon 542 are connected to one another. Here, the ribbons 542 and 544 are connected such that slits 536 and 538 are staggered or stepped. Adhesive 540 on ribbon 544 secures the ribbons 542 and 544 to one another, while the adhesive on ribbon 542 remains exposed for connection to stator core 112.

After connecting ribbons 542 and 544 to one another, bridging portion 546 is removed. This creates a ribbon-like element having strips 533 of conductive layer 532 adhesively bonded to strips 535 of layer 534 where slits 536 in the conductive layer alternate with slits 538 in the insulation layer.

In an alternative embodiment shown in FIG. 14, bridging portion 546 is removed from ribbons 542, but not from ribbons 544. Thus, in this embodiment ribbon 544 remains a single continuous ribbon, having slits 538 disposed therein and ribbon 542 connects to stator core 112 through slits 538 of ribbon 544.

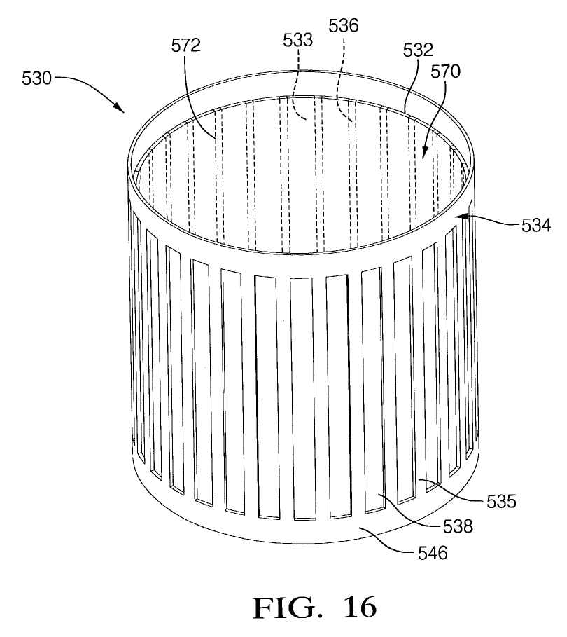

In another alternative embodiment illustrated in FIG. 15, bridging portion 546 is removed from ribbon 542, but from only one end of ribbon 544. Thus, in this embodiment ribbon 544 remains a single continuous ribbon, having slits 538 disposed therein and ribbon 542 connects to stator core 112 through slits 538 of ribbon 544.

Alternately, conducting strips 533 and insulating strips 535 can be manufactured as separate parts without bridging portions 546. Strips 535 are inserted into slots 122 to secure windings 124-and strips 533 are assembled to stator core 112 so that strips 533 are placed equally between adjacent stator slots 122 and slot openings 121 are located at the center of stator slots 122.

The conducting strips 533 can be manufactured as separate parts and the insulating strips 535 can be manufactured as a single ribbon 544 with bridging portions 546 at each end. Ribbon 534 is installed into stator core 112 and inserted into slots 122 to secure windings 124 and conducting strips 533 are assembled to core 112 so that strips 533 are placed equally between adjacent slots 122 and slot openings 121 are located at the center of slots 122.

The conducting strips 533 can also be manufactured as separate parts and the insulating strips 535 can be manufactured as a single ribbon 544 with bridging portions 546 at one end. Ribbon 534 is installed into stator core 112 and inserted into slots 122 to secure windings 124 and conducting strips 533 are assembled to core 112 so that strips 533 are placed equally between adjacent slots 122 and slot openings 121 are located at the center of slots 122.

Referring now to FIG. 16, yet another alternative exemplary embodiment of stator core liner 530 is illustrated. In this embodiment, the conducting layer 532 is initially a continuous sleeve of conductive material 570. The insulating layer 534 is in the form of a sleeve of insulating material. The insulating layer 534 is disposed around the sleeve of conductive material 570. The insulating layer 534 includes the insulating spaces 538, the insulating strips 535, and the bridging portions 546. A trimming operation can be performed on the continuous sleeve 570. The trimming operation forms the conducting strips 533 and the conducting spaces 536 by removing only the material 572 (illustrated in phantom) from the continuous sleeve 570.

Of course and as other applications require, stator core liner 530 manufactured by other processes such that the liner provides both retaining and insulating functions while replacing tooth tips and slot wedges are considered within the scope of the present disclosure. For example, slits 536 being end machined into, or otherwise removed from, conductive layer 532 (e.g., ribbon 542) after insertion and connection to stator core 112 is considered within the scope of the present disclosure.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for manufacturing a stator core of an electric machine, comprising:
inserting a motor winding into a plurality of stator slots defined in said stator core, said motor winding being inserted into said plurality of stator slots through an opening of each of said plurality of stator slots, said opening having a similar dimension to said plurality of slots;
installing an insulating strip into each of said openings; and
installing a magnetically conducting strip in conductive contact with said stator core at opposing sides of each of said plurality of stator slots such that a conducting space is defined by said conducting strips, said conducting space being intermediate to each of said openings, said conductive space restricting said openings to a predetermined dimension, and each of said insulting strips preventing electrical conduction between said conducting strips and said motor winding.

2. The method as in claim 1, further comprising:
connecting each of said conducting strips in contact with said stator core at opposing sides of each of said plurality of stator slots.

3. The method as in claim 2, wherein said insulating strips and said conducting strips comprise a one-piece element.

4. The method as in claim 3, wherein said one-piece element is either a tape-like construction or a ring like construction.

5. The method as in claim 3, wherein installing said insulating strip and said conducting strip comprises:
pushing, pulling, or drawing said one-piece element through said stator core.

6. The method as in claim 2, wherein an insulating space is defined by each of said insulating strips and said conducting space is defined by each of said conducting strips.

7. The method as in claim 6, wherein said insulating strips and said insulating spaces define an insulating layer, and said conducting strips and said conducting spaces define a conducting layer.

8. An insertion tool for inserting a retaining and insulating member into a stator core of an electric machine, comprising:
an inner core; and
a plurality of fingers disposed circumferentially and radially about said inner core, each of said plurality of fingers corresponding to one of a plurality of slots defined within a central bore of the stator core, each of said plurality of fingers being configured to compress or hold motor windings in each of said plurality of slots,
wherein said insertion tool is adapted for movement in an axial direction through said central bore in order to push, pull, or draw said retaining and insulating member into said stator core such that an insulating layer of said retaining and insulating member rests in said plurality of slots and a conducting layer of said retaining and insulating member is in contact with said stator core.

9. The insertion tool as in claim 8, wherein said plurality of fingers are adapted to move in a radial direction between a first and a second position, said first position having a first radial dimension that is smaller than a central bore dimension, and said second position having a second radial dimension that is equal to or slightly larger than said central bore dimension such that said plurality of fingers in said second position are configured to compress or hold said motor windings in said plurality of slots.

10. The insertion tool as in claim 9, wherein said plurality of fingers in said second position are further configured to insert a portion of said insulating layer in said slots and is configured to place a portion of said conducting layer in contact with said stator core.

11. The insertion tool as in claim 8, wherein said plurality of fingers have a radial dimension that is equal to or slightly larger than a central bore dimension such that said plurality of fingers are configured to compress or hold said motor windings in said plurality of slots.

12. The insertion tool as in claim 11, wherein said plurality of fingers further comprise:
a tip width that is equal to or slightly smaller than an opening of said plurality of stator slots; and
a space separating each of said plurality of fingers from one another, said space being equal to or slightly larger than a distance between said stator slots.

13. The insertion tool as in claim 12, wherein said insertion tool is configured to rotate while pushing, pulling, or drawing said retaining and insulating member into said stator core.
